(19) United States
(12) Patent Application Publication
(10) Pub. No.: US 2024/0196985 A1
(43) Pub. Date: Jun. 20, 2024

(54) AEROSOL GENERATING DEVICE AND OPERATING METHOD THEREOF

(71) Applicant: KT&G CORPORATION, Daejeon (KR)

(72) Inventors: Yong Hwan KIM, Gyeonggi-do (KR); Dong Sung KIM, Seoul (KR); Hun II LIM, Seoul (KR); Seok Su JANG, Daejeon (KR)

(73) Assignee: KT&G CORPORATION, Daejeon (KR)

(21) Appl. No.: 18/288,059

(22) PCT Filed: Nov. 22, 2022
(86) PCT No.: PCT/KR2022/018466

§ 371 Date: Oct. 24, 2023

(30) Foreign Application Priority Data
Nov. 24, 2021 (KR) 10-2021-0163726

(51) Int. Cl. A24F 40/51; A24F 40/465; A24F 40/53; A24F 40/60

(52) U.S. Cl. CPC A24F 40/51; A24F 40/465; A24F 40/53; A24F 40/60

(57) ABSTRACT

An aerosol generating apparatus includes: a housing comprising an accommodation space into which an aerosol generating article is inserted; a heater heating an aerosol generating article inserted in the accommodation space; a display arranged on the housing; a sensor positioned to be adjacent to the accommodation space; and a processor configured to detect a type of the aerosol generating article inserted in the accommodation space through the sensor, wherein the processor is further configured to, when the type of the aerosol generating article inserted in the accommodation space is different from a type of a previously inserted aerosol generating article, display a user showing various types of the aerosol generating article through the display.

### TECHNICAL FIELD

One or more embodiments relate to an aerosol generating device capable of displaying a user interface based on the type of an aerosol generating article and an operating method thereof.

### BACKGROUND ART

Recently, the demand for alternative methods to overcome the disadvantages of traditional cigarettes has increased. For example, there is growing demand for an aerosol generating device that generates an aerosol by heating or atomizing an aerosol generating material in a cigarette or a cartridge, instead of burning a cigarette.

Recently, an aerosol generating apparatus that may generate an aerosol by heating an aerosol generating article has been suggested as a way to replace a method of supplying an aerosol by burning cigarettes. For example, the aerosol generating device may be capable of generating an aerosol by heating an aerosol generating material in a liquid or solid state with a heater to a predetermined temperature.

When an aerosol generating device is used, smoking may be performed without additional accessories such as a lighter, and a user's smoking convenience may be enhanced as a user may smoke as much as he/she wants. Thus, research on aerosol generating devices has gradually increased recently.

### DISCLOSURE OF INVENTION

### Technical Problem

An aerosol generating device may generate an aerosol by heating an aerosol generating article inserted into the aerosol generating device, and there may be various types of aerosol generating articles that can be inserted in the aerosol generating device.

According to the type of aerosol generating articles inserted into the aerosol generating device, temperature profiles of a heater to maintain an optimal atomizing performance may be different. For example, when a first aerosol generating article is inserted into the aerosol generating device, the heater needs to be heated according to a first temperature profile to maintain an optimal atomizing performance, and when a second aerosol generating article is inserted into the aerosol generating device, the heater needs to be heated according to a second temperature profile to maintain an optimal atomizing performance.

Accordingly, there is an increasing need for an aerosol generating device that may change the temperature profile of the heater according to the type of the aerosol generating article inserted into the aerosol generating device.

The disclosure provides an aerosol generating device capable of detecting the type of the aerosol generating article and outputting a user interface capable of changing the temperature profile of the heater based on a result of detection to allow a user to select a temperature profile of a heater according to a type of an aerosol generating article, and an operation method of the aerosol generating device.

The technical problems of the present disclosure are not limited to the above-described description, and other technical problems may be clearly understood by one of ordinary skill in the art from the embodiments to be described hereinafter.

### Solution to Problem

According to one or more embodiments, an aerosol generating apparatus may include a housing including an accommodation space into which an aerosol generating article is inserted, a heater configured to heat an aerosol generating article inserted in the accommodation space, a display located on the housing, a sensor positioned to be adjacent to the accommodation space, and a processor configured to detect a type of the aerosol generating article inserted in the accommodation space through the sensor, wherein the processor is further configured to, when the type of the aerosol generating article inserted in the accommodation space is different from the type of a previously inserted aerosol generating article, display a user interface showing various types of the aerosol generating article through the display.

According to one or more embodiments, an operation method of an aerosol generating device may include detecting a type of an aerosol generating article inserted in an accommodation space through a sensor positioned adjacent to the accommodation space, when the type of the aerosol generating article inserted in the accommodation space is different from the type of a previously inserted aerosol generating article, displaying a user interface showing various types of the aerosol generating article through a display, and, based on a user input on the user interface, controlling power supplied to a heater.

### Advantageous Effects of Invention

An aerosol generating device according to one or more embodiments and an operation method thereof may output a user interface (UI) that allows a user to change a temperature profile according to the type of an aerosol generating article.

In addition, an aerosol generating device and an operation method thereof according to one or more embodiments may inform a user when an aerosol generating article is unintentionally inserted.

However, effects of the present disclosure are not limited to the above effects, and effects that are not mentioned could be clearly understood by one of ordinary skill in the art from the present specification and the attached drawings.

### BRIEF DESCRIPTION OF DRAWINGS

FIG. 1 is a perspective view of an aerosol generating apparatus according to an embodiment;

FIG. 2 is a view illustrating an aerosol generating article according to an embodiment;

FIG. 3 is a view schematically illustrating components of the aerosol generating device according to an embodiment;

FIG. 4A is a view showing an arrangement of a sensor in the aerosol generating device of FIG. 3, according to an embodiment;

FIG. 4B is a view showing an arrangement of the sensor in the aerosol generating device of FIG. 3, according to another embodiment;

FIG. 5 is a block diagram of an aerosol generating device according to an embodiment;

FIG. 6 is a view showing a state of a display when an aerosol generating article different from a previously inserted aerosol generating article is inserted in the aerosol generating device according to an embodiment;

FIG. 7 is a flowchart illustrating a method of controlling a display and power supplied to a heater based on the type of the inserted aerosol generating article inserted in the aerosol generating device according to an embodiment;

FIG. 8 is a flowchart illustrating a method for controlling power supplied to the heater based on the user input on the user interface of the aerosol generating device according to an embodiment;

FIG. 9 is a flowchart illustrating a method for controlling power supplied to the heater based on the user input on the user interface of the aerosol generating device according to another embodiment;

FIG. 10 is a diagram showing a state in which a first aerosol generating article is inserted in an aerosol generating device according to another embodiment;

FIG. 11 is a flowchart illustrating a method for controlling power supplied to the heater based on the movement of the aerosol generating article of the aerosol generating device according to another embodiment;

FIG. 12 is a view illustrating a state in which the first aerosol generating article moves in the outward direction from the aerosol generating device according to another embodiment; and

FIG. 13 is a block diagram of an aerosol generating device according to another embodiment.

### MODE FOR THE INVENTION

With respect to the terms used to describe the various embodiments, general terms which are currently and widely used are selected in consideration of functions of structural elements in the various embodiments of the present disclosure. However, meanings of the terms can be changed according to intention, a judicial precedence, the appearance of new technology, and the like. In addition, in certain cases, a term which is not commonly used can be selected. In such a case, the meaning of the term will be described in detail at the corresponding portion in the description of the present disclosure. Therefore, the terms used in the various embodiments of the present disclosure should be defined based on the meanings of the terms and the descriptions provided herein.

In addition, unless explicitly described to the contrary, the word “comprise” and variations such as “comprises” or “comprising” will be understood to imply the inclusion of stated elements but not the exclusion of any other elements. In addition, the terms “-er”, “-or”, and “module” described in the specification mean units for processing at least one function and operation and can be implemented by hardware components or software components and combinations thereof.

As used herein, expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, or all of a, b, and c.

In an embodiment, an aerosol generating device may be a device that generates aerosols by electrically heating a cigarette accommodated in an interior space thereof.

The aerosol generating device may include a heater. In an embodiment, the heater may be an electro-resistive heater. For example, the heater may include an electrically conductive track, and the heater may be heated when currents flow through the electrically conductive track.

The heater may include a tube-shaped heating element, a plate-shaped heating element, a needle-shaped heating element, or a rod-shaped heating element, and may heat the inside or outside of a cigarette according to the shape of a heating element.

A cigarette may include a tobacco rod and a filter rod. The tobacco rod may be formed of sheets, strands, and tiny bits cut from a tobacco sheet. Also, the tobacco rod may be surrounded by a heat conductive material. For example, the heat conductive material may be, but is not limited to, a metal foil such as aluminum foil.

The filter rod may include a cellulose acetate filter. The filter rod may include at least one segment. For example, the filter rod may include a first segment configured to cool aerosols, and a second segment configured to filter a certain component in aerosols.

In another embodiment, the aerosol generating device may be a device that generates aerosols by using a cartridge containing an aerosol generating material.

The aerosol generating device may include a cartridge that contains an aerosol generating material, and a main body that supports the cartridge. The cartridge may be detachably coupled to the main body, but is not limited thereto. The cartridge may be integrally formed or assembled with the main body, and may also be fixed to the main body so as not to be detached from the main body by a user. The cartridge may be mounted on the main body while accommodating an aerosol generating material therein. However, the disclosure is not limited thereto. An aerosol generating material may also be injected into the cartridge while the cartridge is coupled to the main body.

The cartridge may contain an aerosol generating material in any one of various states, such as a liquid state, a solid state, a gaseous state, a gel state, or the like. The aerosol generating material may include a liquid composition. For example, the liquid composition may be a liquid including a tobacco-containing material having a volatile tobacco flavor component, or a liquid including a non-tobacco material.

The cartridge may be operated by an electrical signal or a wireless signal transmitted from the main body to perform a function of generating aerosols by converting the phase of an aerosol generating material inside the cartridge into a gaseous phase. The aerosols may refer to a gas in which vaporized particles generated from an aerosol generating material are mixed with air.

In another embodiment, the aerosol generating device may generate aerosols by heating a liquid composition, and the generated aerosols may be delivered to a user through a cigarette. That is, the aerosols generated from the liquid composition may move along an airflow passage of the aerosol generating device, and the airflow passage may be configured to allow aerosols to be delivered to a user by passing through a cigarette.

In another embodiment, the aerosol generating device may be a device that generates aerosols from an aerosol generating material by using an ultrasonic vibration method. In this case, the ultrasonic vibration method may refer to a method of generating an aerosol by atomizing an aerosol generating material by using ultrasonic vibration generated by a vibrator.

The aerosol generating device may include a vibrator, and the vibrator may generate a short period of vibration to atomize the aerosol generating material. The vibration generated by the vibrator may be an ultrasound vibration, and the frequency band of the ultrasound vibration may be about 100 kHz to about 3.5 MHz, but is not limited thereto.

The aerosol generating device may further include a wick that absorbs the aerosol generating material. For example, the wick may be arranged to wrap at least one area of the vibrator or to be in contact with at least one area of the vibrator.

As the voltage (e.g., AC voltage) is applied to the vibrator, heat and/or ultrasonic vibration may be generated from the vibrator, and the heat and/or ultrasonic vibration generated from the vibrator may be transmitted to the aerosol generating material absorbed into the wick. The aerosol generating material absorbed into the wick may be converted to a gas phase by heat and/or ultrasonic vibration transmitted from the vibrator, and as a result, aerosol may be generated.

For example, the viscosity of the aerosol generating material absorbed into the wick by the heat generated from the vibrator may be lowered, and the aerosol generating material of which the viscosity is lowered by the ultrasonic vibration generated from the vibrator may be divided into fine particles, thereby generating aerosol, but embodiments are not limited thereto.

In another embodiment, the aerosol generating device is a device that generates aerosols by heating an aerosol generating article accommodated in the aerosol generating device in an induction heating method.

The aerosol generating device may include a susceptor and a coil. In an embodiment, the coil may apply a magnetic field to the susceptor. As power is supplied to the coil from the aerosol generating device, a magnetic field may be formed inside the coil. In an embodiment, the susceptor may be a magnetic body that generates heat by an external magnetic field. As the susceptor is positioned inside the coil and a magnetic field is applied to the susceptor, the susceptor generates heat to heat an aerosol generating article. In addition, optionally, the susceptor may be positioned within the aerosol generating article.

In another embodiment, the aerosol generating device may further include a cradle.

The aerosol generating device may configure a system together with a separate cradle. For example, the cradle may charge a battery of the aerosol generating device. Alternatively, the heater may be heated when the cradle and the aerosol generating device are coupled to each other.

Hereinafter, the disclosure will now be described more fully with reference to the accompanying drawings, in which exemplary embodiments of the disclosure are shown such that one of ordinary skill in the art may easily work the disclosure. The disclosure may be implemented in a form that can be implemented in the aerosol generating devices of the various embodiments described above or may be implemented in various different forms, and is not limited to the embodiments described herein.

Hereinafter, embodiments of the disclosure will be described in detail with reference to the drawings.

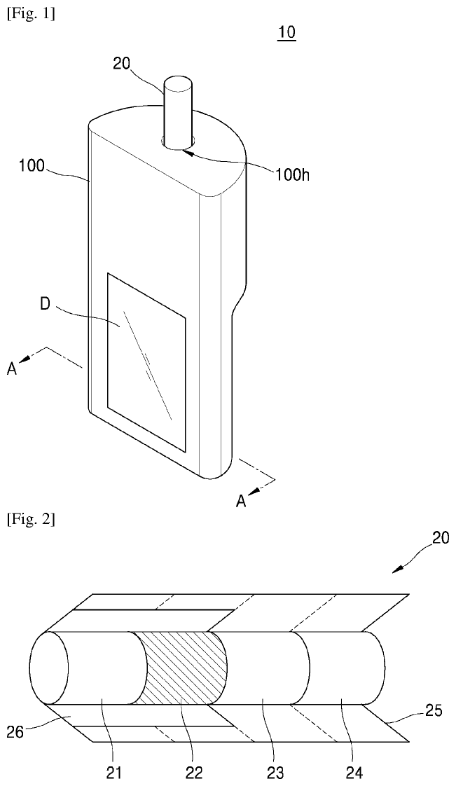

FIG. 1 is a perspective view of an aerosol generating apparatus according to an embodiment.

Referring to FIG. 1, an aerosol generating apparatus 10 according to an embodiment may include a housing 100 into which an aerosol generating article 20 may be inserted.

The housing 100 may constitute the overall appearance of the aerosol generating apparatus 10, and may include an internal space (or an ‘arrangement space’) in which components of the aerosol generating apparatus 10 may be arranged. In the drawings, the cross-section of the housing 100 is a semicircular shape, but the shape of the housing 100 is not limited thereto. For example, the housing 100 may be formed generally in a cylindrical shape or a polygonal column (e.g., a triangular column or a square column).

Components for generating an aerosol by heating the aerosol generating article 20 inserted into the housing 100, and components for detecting an amount of moisture of the aerosol generating article 20 may be arranged inside the housing 100, and a detailed description thereof will be provided later.

In an embodiment, the housing 100 may include an accommodation space 100h through which the aerosol generating article 20 may be inserted into the housing 100. At least a portion of the aerosol generating article 20 may be inserted into or accommodated in the housing 100 through the accommodation space 100h.

The aerosol generating article 20 inserted into or accommodated in the housing 100 may be heated inside the housing 100, and thus, an aerosol may be generated from the aerosol generating article 20. The aerosol generated from the aerosol generating article 20 may be discharged to the outside of the aerosol generating device 10 through the aerosol generating article 20 and/or a space between the aerosol generating article 20 and the accommodation space 100h, and the user may inhale the aerosol discharged to the outside.

The aerosol generating device 10 according to an embodiment may further include a display D on which visual information is displayed.

The display D may be positioned such that at least an area thereof is exposed to the outside of the housing 100. For example, at least an area of the display D may be exposed to the outside of the housing 100 through a cover glass of the housing 100, but embodiments are not limited thereto.

The aerosol generating device 10 may output various visual information through the display D or may control operations of the components of the aerosol generating device 10 based on a user input that is input on the display D.

In an embodiment, the aerosol generating device 10 may output information such as a pre-heating time or the number of puffs regarding the aerosol generating article 20 inserted into the accommodation space 100h through the display D. However, the information output through the display D is not limited to the above-described embodiment.

In another embodiment, the aerosol generating device 10 may detect a user input that is input on the display D, and may control power supplied to the heater (not shown) heating the aerosol generating article 20 inserted based on the user input, but embodiments are not limited thereto.

FIG. 2 is a view illustrating an aerosol generating article according to an embodiment. FIG. 2 schematically shows a structure of the aerosol generating article 20 which may be an embodiment of the aerosol generating article inserted in the aerosol generating device 10 of FIG. 1.

Referring to FIG. 2, the aerosol generating article 20 according to an embodiment may include a first portion 21, a second portion 22, a third portion 23, and a fourth portion 24.

The first portion 21, the second portion 22, the third portion 23, and the fourth portion 24 may include an aerosol generating element, a tobacco element, a cooling element, and a filter element, respectively. For example, the first portion 21 may include an aerosol generating material, the second portion 22 may include a tobacco material and a moisturizer, the third portion 23 may cool the aerosol passing therethrough, and the fourth portion 24 may include a filter material.

In an embodiment, the first portion 21, the second portion 22, the third portion 23, and the fourth portion 24 may be arranged sequentially in a longitudinal direction of the aerosol generating article 20. In this disclosure, the longitudinal direction of the aerosol generating article 20 may be a direction in which a length of the aerosol generating article 20 extends. A longitudinal direction of the aerosol generating article 20 may refer to, for example, a direction from the first portion 21 to the fourth portion 24.

The first portion 21 and/or the second portion 22 of the aerosol generating article 20 may be heated by the aerosol generating device (e.g., the aerosol generating device 10 of FIG. 1) to generate an aerosol. Because the first portion 21, the second portion 22, the third portion 23, and the fourth portion 24 are aligned in the longitudinal direction of the aerosol generating article 20, the aerosol generated in the first portion 21 and the second portion 22 may sequentially pass through the first portion 21, the second portion 22, the third portion 23, and the fourth portion 24 and form air flow. Accordingly, the user may put the fourth portion 24 in the mouth and inhale the aerosol discharged from the fourth portion 24.

The first portion 21 may include an aerosol generating element. In addition, the first portion 21 may also contain other additives such as flavors, a wetting agent, and/or organic acid, and may contain a flavored liquid such as menthol or a moisturizer. The aerosol generating element may include at least one of, for example, glycerin, propylene glycol, ethylene glycol, dipropylene glycol, diethylene glycol, triethylene glycol, tetraethylene glycol, and oleyl alcohol. The aerosol generating element is not limited to the above embodiment, and the first portion 21 may further include various types of aerosol generating elements according to embodiments.

The first portion 21 may include a crimped sheet, and the aerosol generating element may be included in the first portion 21 by being impregnated in the crimped sheet. In addition, other additives such as flavors, a wetting agent, and/or organic acid may be included in the first portion 21 in a state of being absorbed into the crimped sheet.

The crimped sheet may include, for example, at least one of a paper, cellulose acetate, lyocell, and polylactic acid. For example, the crimped sheet may be a paper sheet that does not generate a smell due to heat even when heated to a high temperature, but embodiments are not limited thereto.

The second portion 22 may include a tobacco element. The tobacco element may include a certain type of tobacco material. For example, the tobacco element may include a type of pipe tobacco, a type of tobacco particle, a type of tobacco sheet, a type of tobacco beads, a type of tobacco granule, a type of tobacco powder, or a type of tobacco extract. Also, the tobacco material may include for example a tobacco leaf, lateral veins of tobacco leaves, puff tobacco, a cut tobacco pipe, a tobacco sheet, and/or reformulated tobacco.

The third portion 23 may cool airflow passing through the third portion 23. The third portion 23 may be made of a polymer material or a biodegradable polymer material and may have a cooling function. For example, the third portion 23 may be made of a polyactic acid (PLA) fiber, but is not limited thereto. Alternatively, the third portion 23 may be made of a cellulose acetate filter having a plurality of holes. However, the third portion 23 is not limited to the above-described examples and may include any material which may cool aerosol without limit. For example, the third portion 23 may include a tube filter or a paper pipe including a cavity.

The third portion 23 may include a tube-type structure including a cavity, and an inner surface of the cavity may be coated with at least one type of material selected from the group consisting of PLA and a flavor material.

The PLA is coated on the inner surface of the cavity and may effectively cool the aerosol by phase variation. For example, the PLA may cause heat-absorbing phase variation, such as fusion or glass transition. The heat energy of the aerosol passing through the inner surface of the cavity may be used for the phase variation of the PLA, and thus, the temperature of the aerosol may be effectively reduced.

The flavor material coated on the inner surface of the cavity may add a flavor to the aerosol passing through the inner surface of the cavity. The flavor material may refer to a material for adding a specific flavor. For example, the flavor material may include vegetable spices, such as cinnamon, sage, herb, chamomile, winter hay, lavender, bergamot, a lemon, an orange, cinnamon, jasmine, ginger, vanilla, spearmint, peppermint, acacia, coffee, salary, sandalwood, cocoa, etc.

As another example, the flavor material may include animal spices, such as musk, ambergris, civet, castoreum, etc.

As another example, the flavor material may include an alcohol-based compound, such as menthol, geraniol, linalol, anethol, eugenol, etc. Also, the flavor material may include an aldehyde-based compound, such as vanillin, benzaldehyde, anisaldehyde, etc. Also, the flavor material may include an ester-based compound, such as isoamyl acetate, linalyl acetate, isoamyl propionate, linalyl butyrate, etc. Preferably, the flavor material may include menthol.

The fourth portion 24 may include a filter material. For example, the fourth portion 24 may be a cellulose acetate filter. The shape of the fourth portion 24 is not limited. For example, the fourth portion 24 may be a cylindrical-type rod or a tube-type rod including a hollow therein. In addition, the fourth portion 24 may be a recess-type rod. If the fourth portion 24 includes a plurality of segments, at least one of the plurality of segments may also have a different shape.

The fourth portion 24 may be formed to generate one or more flavors. For example, a liquid flavor material may be injected into the fourth portion 24, or an additional fibers impregnated with a flavor material may be inserted into the fourth portion 24. For example, the fibers impregnated with the flavor material may be arranged in the fourth portion 24 in the longitudinal direction of the aerosol generating article 20. The fibers impregnated with the flavor material may be formed by using, for example, such as cellulose acetate, cotton, PLA, etc., but it is not limited thereto. Also, with respect to the fibers impregnated with the flavor material, the amount of impregnated flavor material may be controlled by adjusting a thickness of the fibers, the number of the fibers, etc.

Also, the fourth portion 24 may include at least one capsule. For example, the capsule may include a flavor material, and when the capsule is broken, a flavor may be generated due to the leaked flavor material. As another example, the capsule may include an aerosol generating material, and when the capsule is broken, aerosol may be generated from the leaked material. The capsule may have a structure in which the aerosol generating material is wrapped by a thin film. The capsule may have a spherical or a cylindrical shape, but is not limited thereto.

The aerosol generating article 20 according to an embodiment may further include a wrapper 25 and a thermally conductive thin film 26 wrapping at least a portion of the first portion 21 to the fourth portion 24.

The wrapper 25 may be located at an outermost layer of the aerosol generating article 20, and may wrap at least a portion of the first portion 21 to the fourth portion 24 or wrap all of the first portion 21 to the fourth portion 24, but embodiments are not limited thereto. In addition, the wrapper 25 may be a single wrapper, but may also be a combination of a plurality of wrappers according to an embodiment.

When the thermally conductive thin film 26 is inserted into the aerosol generating device (e.g., the aerosol generating device 10 of FIG. 1), the thermally conductive thin film 26 may be located in a position corresponding to the heater to uniformly distribute heat generated from the heater to the first portion 21 and/or the second portion 22.

In an embodiment, the thermally conductive thin film 26 may include a material having excellent thermal conductivity, and may be positioned to wrap the first portion 21 and/or the second portion 22 heated by the heater of the aerosol generating device to uniformly distribute heat generated from the heater to the first portion 21 and/or the second portion 22. For example, the thermally conductive thin film 26 may include at least one of aluminum, platinum, and rutinum, which have excellent thermal conductivity, but embodiments are not limited thereto.

In an embodiment, the size, shape, material, and the like of the thermally conductive thin film 26 may change according to the type of the aerosol generating article 20. Accordingly, the aerosol generating device may detect the type of the aerosol generating article 20 and/or the movement of the aerosol generating article 20 based on the electrical characteristic changes inside the aerosol generating device due to the thermally conductive thin film 26 of the aerosol generating article 20, and details thereof will be described later.

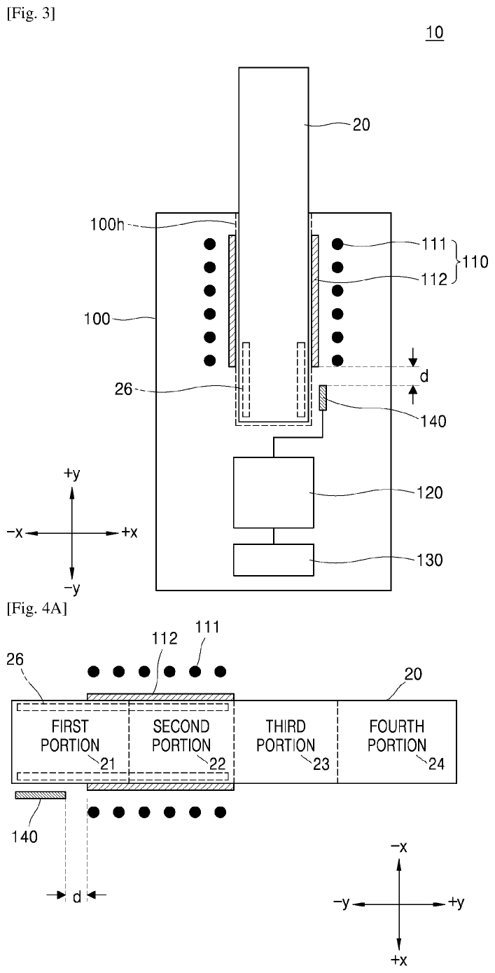

FIG. 3 is a view schematically illustrating components of the aerosol generating device according to an embodiment. FIG. 3 is a cross-sectional view of the aerosol generating device 10 shown in FIG. 1 taken along a line A-A′ and illustrates part of the configurations inside the housing 100. In addition, the aerosol generating article 20 inserted into the aerosol generating device 10 of FIG. 3 may be the aerosol generating article 20 of FIG. 2, and overlapping descriptions are omitted below.

Referring to FIG. 3, the aerosol generating device 10 (e.g., the aerosol generating device 10 of FIG. 1) according to an embodiment may include the housing 100 (e.g., the housing 100 of FIG. 1), a heater 110, a processor 120, a battery 130, and a sensor 140. Components of the aerosol generating device 10 according to an embodiment are not limited thereto, and according to an embodiment, at least one component may be added to or omitted from the aerosol generating device 10.

The housing 100 may include an inner space in which the components of the aerosol generating device 10 may be arranged. For example, the heater 110, the processor 120, the battery 130, and the sensor 140 may be arranged in the inner space of the housing 100, but components arranged in the inner space are not limited to the embodiments described above.

In an embodiment, the housing 100 may include the accommodation space 100h (e.g., accommodation space 100h of FIG. 1) in which the aerosol generating article 20 may be inserted or accommodated. For example, at least a portion of the aerosol generating article 20 may be inserted or accommodated in the housing 100 through the accommodation space 100h.

The heater 110 may be located in the inner space of the housing 100 and may heat the aerosol generating article 20 inserted or accommodated in the housing 100 to generate an aerosol. For example, the heater 110 may generate heat as power is supplied from the battery 130, thereby heating at least a portion of the aerosol generating article 20. Aerosol may be generated when vaporized particles are generated as the aerosol generating article 20 is heated, and the aerosol is mixed with air which flows into the housing 100 from outside.

In an embodiment, the heater 110 may include an induction heating-type heater. For example, the heater 200 may include an induction coil 111 generating an alternating magnetic field as power is supplied, and a susceptor 112 generating heat by the alternating magnetic field generated in the induction coil 111.

In an embodiment, the induction coil 111 may surround an outer circumferential surface of the susceptor 112, and the susceptor 112 may surround at least a portion of the outer circumferential surface of the aerosol generating article 20 inserted or accommodated in the housing 100. For example, the susceptor 112 may surround at least a portion including the aerosol generating material (e.g., the first portion 21 of FIG. 2) and/or including tobacco material (e.g., the second portion 22 of FIG. 2) of the aerosol generating article 20, but embodiments are not limited thereto.

Although not illustrated in the figures, the heater 110 may include an electro-resistive heater according to another embodiment. For example, the heater 110 may include a film heater surrounding at least a portion of the outer circumferential surface of the aerosol generating article 20 inserted or accommodated in the housing 100. The film heater may include an electrically conductive track, and as power flows through the electrically conductive track, the film heater may generate heat to heat the aerosol generating article 20 inserted in the housing 100.

In another embodiment, the heater 110 may include at least one of a needle type heater, a rod type heater, and a tube type heater that may heat the inside of the aerosol generating article 20 inserted in the housing 100. For example, the above-described heater may be inserted in at least one region of the aerosol generating article 20 to heat the inside of the aerosol generating article 20.

The heater 110 is not limited to the above-described embodiments, and the heater 110 may be implemented as various embodiments as long as it can heat the aerosol generating article 20 to a designated temperature of the aerosol generating article 20. In this disclosure, “designated temperature” may refer to a temperature at which the aerosol generating material and/or tobacco material included in the aerosol generating article 20 may be heated to discharge aerosol and/or nicotine, and the designated temperature may be changed by the type of the aerosol generating device 10, the type of the aerosol generating article 20, and/or a manipulation of the user.

The processor 120 may entirely control the operation of the aerosol generating device 10. In an embodiment, the processor 120 may be electrically or operatively connected to the heater 110 and the battery 130 to thereby control the power supplied from the battery 130 to the heater 110. In another embodiment, the processor 120 may be electrically or operatively connected to the sensor 140 to detect the type of the aerosol generating article 20 inserted in the housing 100 and/or whether the inserted aerosol generating article has moved through the sensor 140. Details thereof will be described later.

In the present disclosure, the expression “operatively connected” may refer to a state in which components are connected to transmit and receive signals in a wireless communication manner or to transmit and receive optical signals and/or magnetic signals, and the corresponding expressions may be used in the same sense even in the following.

The battery 130 may supply power required for the operation of the aerosol generating device 10. For example, the battery 130 may supply power to the heater 110 to heat the aerosol generating article 20. In another example, the battery 130 may supply power required for the operation of the processor 120 or may supply power required for the operation of the sensor 140.

The sensor 140 may be electrically or operatively connected to the processor 120, and may be used for detecting the type of the aerosol generating article 20 inserted to the accommodation space 100h and/or the movement of the aerosol generating article 20 by being arranged adjacent to the accommodation space 100h of the housing 100.

In an embodiment, the processor 120 may detect the type of the aerosol generating article 20 inserted into the accommodation space 100h through the sensor 140. For example, the processor 120 may detect whether the aerosol generating article 20 inserted into the accommodation space 100h is a first aerosol generating article or a second aerosol generating article through the sensor 140.

Because the aerosol generating article 20 includes the thermally conductive thin film 26 (e.g., the thermally conductive thin film 26 of FIG. 2) therein, the electrical characteristics inside the accommodation space 100h may change when the aerosol generating article 20 is inserted into the accommodation space 100h. In this case, the size, shape, material, etc. of the thermally conductive thin film 26 included in the aerosol generating article 20 may vary according to the type of the aerosol generating article 20, and thus, electrical characteristic changes inside the accommodation space 100h may vary according to the type of the aerosol generating article 20 inserted into the accommodation space 100h.

Accordingly, the processor 120 may detect the electrical characteristic changes inside the accommodation space 100h through the sensor 140, and may detect the type of the aerosol generating article 20 inserted into the accommodation space 100h based on the result of detection.

In another embodiment, the processor 120 may detect the movement of the aerosol generating article 20 inserted into the accommodation space 100h through the sensor 140. For example, the processor 120 may detect the inserted aerosol generating article 20 moving from the accommodation space 100h to an outward direction through the sensor 140. In this disclosure, “outward direction” may refer to a direction from the accommodation space 100h toward the outside of the aerosol generating device 10 (e.g., a +y direction of FIG. 3), and the expression may be used with the same meaning here below.

When the aerosol generating article 20 enters the accommodation space 100h or is removed from the accommodation space 100h, due to the thermally conductive thin film 26 included in the aerosol generating article 20, the electrical characteristics inside the accommodation space 100h may change.

Accordingly, the processor 120 may detect the electrical characteristic changes inside the accommodation space 100h through the sensor 140, and may detect the movement of the aerosol generating article 20 inserted into the accommodation space 100h or whether the aerosol generating article 20 has been removed based on the result of detection.

In an embodiment, the sensor 140 may include an inductance sensor that detects an inductance value corresponding to the type of the aerosol generating article 20 inserted in the accommodation space 100h and/or the movement of the aerosol generating article 20. For example, the sensor 140 may detect an inductance value inside of the accommodation space 100h, the inductance value corresponding to the type of the aerosol generating article 20 inserted in the accommodation space 100h and/or the movement of the aerosol generating article 20.

The processor 120 may obtain an inductance value corresponding to the type of the aerosol generating article 20 and/or the movement of the aerosol generating article 20 from the sensor 140, and may detect the type of the aerosol generating article 20 inserted in the accommodation space 100h and/or movement of the aerosol generating article 20 based on the obtained inductance value. Detailed description thereof will be provided later.

The type of the sensor 140 is not limited to the inductance sensor, and the sensor 140 may include a different sensor (e.g., a capacitative sensor) capable of detecting the electrical characteristic changes inside the accommodation space 100h to detect the type of the inserted aerosol generating article 20 and/or the movement of the aerosol generating article 20.

In an embodiment, the sensor 140 may be positioned apart from at least one of the induction coil 111 and the susceptor 112 in the longitudinal direction of the housing 100 (e.g., the +y direction or the −y direction in FIG. 3). For example, the sensor 140 may be positioned apart from the induction coil 111 and/or the susceptor 112 by a designated distance so that sensor sensitivity does not decrease due to the magnetic field generated from the induction coil 111. In this disclosure, the “designated distance” may refer to a distance at which the intensity of the magnetic field generated from the induction coil 111 becomes lower than a preset value. Accordingly, when the sensor 140 is apart from an end portion of the induction coil 111 and/or the susceptor 112 at least by a designated distance d, a decrease in sensitivity due to the magnetic field generated by the induction coil 111 may be prevented.

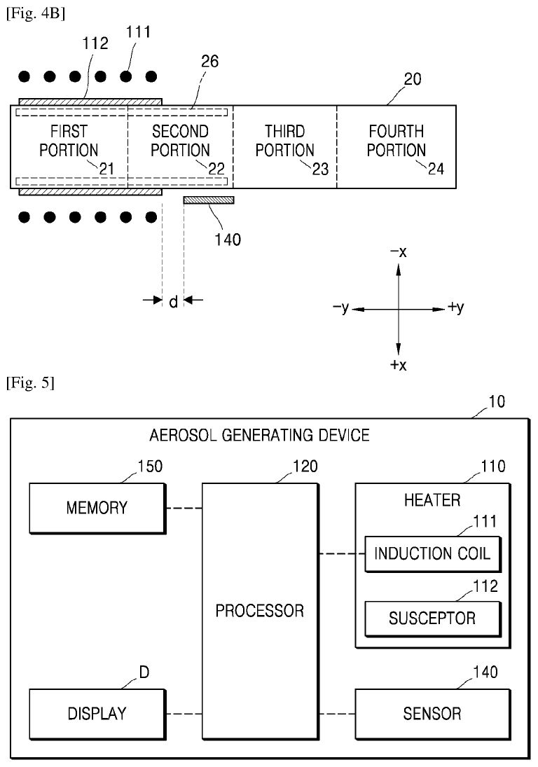

Hereinafter, referring to FIGS. 4A and 4B, the arrangement structure of the sensor 140 according to various embodiments will be described in detail.

FIG. 4A is a view showing an arrangement of the sensor in the aerosol generating device of FIG. 3, according to an embodiment. FIG. 4A shows a state in which the sensor 140 in the aerosol generating device (e.g., the aerosol generating device 10 of FIG. 3) according to an embodiment is positioned apart from the induction coil 111 and/or the susceptor 112 in the −y direction. The aerosol generating article 20 shown in FIG. 4A may be the same as or similar to the aerosol generating article 20 of FIG. 2, and overlapping descriptions are omitted below.

Referring to FIG. 4A, the sensor 140 is positioned to be adjacent to the aerosol generating article 20 when the aerosol generating article 20 is inserted in the accommodation space (e.g., the accommodation space 100h of FIG. 3). Thus, the sensor 140 may detect the inductance value according to the type of the aerosol generating article 20 and/or the movement of the aerosol generating article 20.

In an embodiment, the sensor 140 may be positioned apart from the induction coil 111 and/or the susceptor 112 in a first direction (e.g., the −y direction) parallel to the longitudinal direction of the housing (e.g., the housing 100 of FIG. 3). In this disclosure, the “first direction” may refer to a direction opposite to the direction of movement of the aerosol generated from the aerosol generating article 20.

In an embodiment, the aerosol generating article 20 may include a thermally conductive thin film 26 (e.g., the thermally conductive thin film 26 of FIG. 2) wrapping at least an area of the first portion (e.g., the first portion 21 of FIG. 2) and/or the second portion 22 (e.g., the second portion 22 of FIG. 2), and the sensor 140 may be positioned to be adjacent to the thermally conductive thin film 26 of the aerosol generating article 20.

For example, the induction coil 111 and/or the susceptor 112 may surround at least an area of the first portion 21 including the aerosol generating material and the second portion 22 including the tobacco material. In this case, the sensor 140 may be positioned to be apart from at least one of the induction coil 111 and the susceptor 112 in the first direction by a designated distance d and may be adjacent to an area of the thermally conductive thin film 26 wrapping the first portion 21.

Because the sensor 140 is positioned to be adjacent to an area of the thermally conductive thin film 26 wrapping the first portion 21, when the aerosol generating article 20 is inserted, the sensor 140 may detect a change in the inductance value according to the insertion of the aerosol generating article 20 and/or the induction change according to the movement of the inserted aerosol generating article 20 in the outward direction (e.g., the +y direction).

FIG. 4B is a view showing an arrangement of the sensor in the aerosol generating device of FIG. 3, according to another embodiment. FIG. 4A shows a state in which the sensor 140 in the aerosol generating device (e.g., the aerosol generating device 10 of FIG. 3) according to another embodiment is positioned apart from the induction coil 111 and/or the susceptor 112 in the +y direction. The aerosol generating article 20 shown in FIG. 4B may be the same as or similar to the aerosol generating article 20 of FIG. 2, and overlapping descriptions are omitted below.

Referring to FIG. 4B, the sensor 140 may be positioned apart from the induction coil 111 and/or the susceptor 112 in a second direction (e.g., the +y direction) which opposite to the longitudinal direction of the housing (e.g., the housing 100 of FIG. 3). In this disclosure, the “second direction” may refer to a direction identical to the direction of movement of the aerosol generated from the aerosol generating article 20.

In an embodiment, the aerosol generating article 20 may include a thermally conductive thin film 26 (e.g., the thermally conductive thin film 26 of FIG. 2) wrapping at least an area of the first portion (e.g., the first portion 21 of FIG. 2) and/or the second portion 22 (e.g., the second portion 22 of FIG. 2), and the sensor 140 may be positioned to be adjacent to the thermally conductive thin film 26 of the aerosol generating article 20.

For example, the induction coil 111 and/or the susceptor 112 may surround at least an area of the first portion 21 including the aerosol generating material and the second portion 22 including the tobacco material. In this case, the sensor 140 may be positioned to be apart from at least one of the induction coil 111 and the susceptor 112 in the second direction by a designated distance d and may be adjacent to an area of the thermally conductive thin film 26 wrapping the second portion 22.

Because the sensor 140 is positioned to be adjacent to an area of the thermally conductive thin film 26 wrapping the second portion 22, when the aerosol generating article 20 is inserted, the sensor 140 may detect a change in the inductance value according to the insertion of the aerosol generating article 20 and/or the induction change according to the movement of the inserted aerosol generating article 20 in the outward direction (e.g., the +y direction).

The aerosol generating device (e.g., the aerosol generating device 10 of FIG. 3) may obtain an inductance value corresponding to the type of the aerosol generating article 20 and/or the movement of the inserted aerosol generating article 20 from the sensor 140, and based on the inductance value, the type and/or the movement of the inserted aerosol generating article 20 may be detected. Details thereof will be described later.

FIG. 5 is a block diagram of an aerosol generating device according to an embodiment.

Referring to FIG. 5, the aerosol generating device 10 (e.g., the aerosol generating device 10 of FIG. 3) according to an embodiment may include the heater 110 (e.g., the heater 110 of FIG. 3), the processor 120 (e.g., the processor 120 of FIG. 3), the sensor 140 (e.g., the sensor 140 of FIG. 3), a memory 150, and a display D. At least one of the components of the aerosol generating device 10 according to an embodiment may be the same as or similar to at least one of the components of the aerosol generating device 10 of FIG. 1 and/or FIG. 3. Hereinafter, overlapping descriptions are omitted.

The processor 120 may be electrically or operatively connected to the heater 110, the sensor 140, the memory 150, and/or the display D to thereby control the overall operation of the aerosol generating device 10.

In an embodiment, the sensor 140 may be an inductance sensor detecting an inductance value corresponding to the insertion of the aerosol generating article (e.g., the aerosol generating article 20 of FIG. 3) or the movement of the aerosol generating article inserted in the aerosol generating device 10. The processor 120 may obtain the inductance value from the sensor 140, and based on the inductance value obtained from the sensor 140, may detect the type of the aerosol generating article inserted in the aerosol generating device 10 and/or the movement of the aerosol generating article.

In an embodiment, the processor 120 may detect whether the aerosol generating article inserted in the aerosol generating device 10 is different from the previously inserted aerosol generating article based on the inductance value obtained from the sensor 140 and data stored in the memory 150. In this disclosure, the “previously inserted aerosol generating article” may refer to an aerosol generating article that was recently inserted in the aerosol generating device 10 and then removed before the currently inserted aerosol generating article, and the expression may be used with the same meaning below.

In an embodiment, the memory 150 may store data regarding an inductance value corresponding to an aerosol generating article previously inserted in the aerosol generating device 10. The processor 120 may detect whether the inserted aerosol generating article is different from the previously inserted aerosol generating article by comparing the inductance value corresponding to the inserted aerosol generating article with the inductance value stored in the memory 150 (i.e., inductance value corresponding to the previously inserted aerosol generating article).

In another embodiment, the processor 120 may detect movement of the aerosol generating article inserted in the aerosol generating device 10 based on the inductance value obtained from the sensor 140. For example, when the amount of change of inductance value obtained from the sensor 140 is greater than or equal to a designated value, the processor 120 may detect that the aerosol generating article moved in the outward direction.

In this disclosure, the “designated value” may refer to a reference value for detecting the movement of the aerosol generating article inserted in the aerosol generating device 10. For example, when the amount of change of the inductance value obtained from the sensor 140 is greater than or equal to a designated value, it may be determined that a change of the inductance value has been detected due to the movement of the aerosol generating article. On the other hand, when the amount of the inductance value obtained from the sensor 140 is less than the designated value, it may be determined that a change of the inductance value has been detected due to noise.

In an embodiment, the processor 120 may detect the type of the aerosol generating article inserted in the aerosol generating device 10 through the sensor 140, and a user interface (UI) showing the type of the aerosol generating article may be output through the display D based on the inserted aerosol generating article. For example, when the type of the aerosol generating article is different from that of the previously inserted aerosol generating article, the processor 120 may output a user interface that allows a user to select the type of aerosol generating article through the display D.

In an embodiment, the user interface may include at least one object corresponding to the type of the aerosol generating article. For example, the user interface may include a first object corresponding to a first aerosol generating article, a second object corresponding to a second aerosol generating article, and a third object corresponding to a third aerosol generating article, but embodiments are not limited thereto.

The processor 120 may control power supplied to the heater 110 based on a user input for at least one object of the user interface. For example, the processor 120 may control power supplied to the induction coil 111 of the heater 110 based on the user input for at least one object shown in the user interface.

In this disclosure, the “user input” may include a touch input in which a part of the user's body (such as a finger) is in contact with the display D and/or a hovering input in which a part of the user's body approaches the display D, but embodiments are not limited thereto.

In an embodiment, when the user input is input in the first object corresponding to the first aerosol generating article, the processor 120 may provide a first power to the induction coil 111 of the heater 110 so that the susceptor 112 of the heater 110 may emit heat according to a first temperature profile.

In this disclosure, the “first temperature profile” may refer to a temperature change of the heater 110 over time, which is configured for maintaining an optimal atomizing performance of the first aerosol generating article. For example, when the first power is supplied to the induction coil 111, the susceptor 112 may emit heat according to the first temperature profile.

The atomizing performance may refer to the amount of aerosol generated from the aerosol generating article, a flavor of the aerosol, and the like, and the expression may be used with the same meaning here below.

In another embodiment, when the user input for the second object corresponding to the second aerosol generating article is received, the processor 120 may provide a second power to the induction coil 111 of the heater 110 so that the susceptor 112 of the heater 110 may emit heat according to a second temperature profile.

In this disclosure, the “second temperature profile” may refer to a temperature change of the heater 110 over time, which is configured for maintaining an optimal atomizing performance of the second aerosol generating article. For example, when the second power is supplied to the induction coil 111, the susceptor 112 may emit heat according to the second temperature profile. Similarly, “the Nth (N is a natural number) temperature profile” may refer to a change in the temperature of the heater 110 over time, which is configured for maintaining the optimal atomizing performance of the Nth aerosol generating article, and the expression may be used with the same meaning here below.

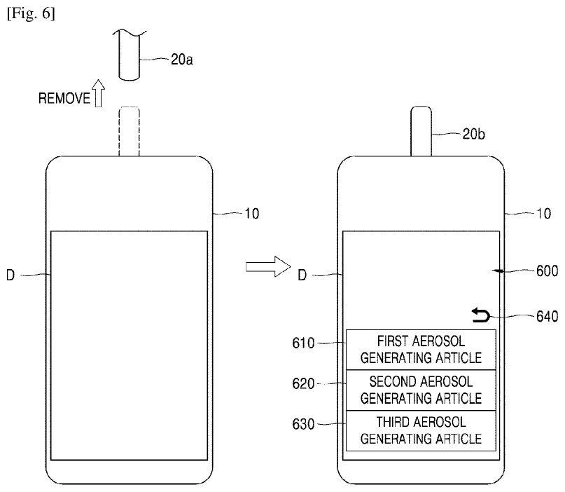

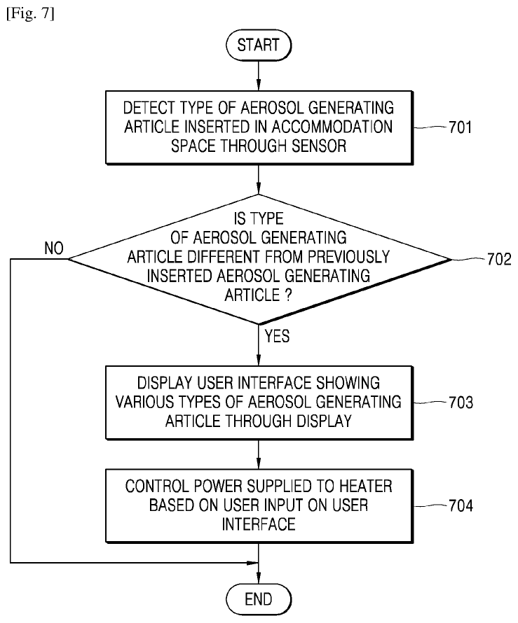

Referring to FIG. 6, an operation in which the processor 120 outputs a user interface through the display D will be described below.

FIG. 6 is a view showing a state of a display when an aerosol generating article different from a previously inserted aerosol generating article is inserted in the aerosol generating device according to an embodiment.

Referring to FIG. 6, the aerosol generating device 10 according to an embodiment may output a user interface 600 showing various types of the aerosol generating article through the display D when the type of the aerosol generating article is different from that of the previously inserted aerosol generating article.

For example, the aerosol generating device 10 may output the user interface 600 showing various types of the aerosol generating article when a second aerosol generating article 20b is a different type than the first aerosol generating article 20a. In this case, the user may input the user input on the user interface that is output on the display D to select the temperature profile of the heater so that the heater (e.g., the heater 110 of FIG. 3) is heated according to a temperature profile suitable for the inserted aerosol generating article 20b.

The aerosol generating device 10 may detect the user input on the user interface 600, and may control power supplied to the heater based on the user input.

In an embodiment, the user interface 600 may include the first object 610 corresponding to the first aerosol generating article 20a, the second object 620 corresponding to the second aerosol generating article 20b different from the first aerosol generating article 20a, and the third object 630 corresponding to the third aerosol generating article different from the first aerosol generating article 20a and the second aerosol generating article 20b.

For example, the processor (e.g., the processor 120 of FIG. 3) of the aerosol generating device 10 may supply the first power to the heater so that the heater emits heat according to the first temperature profile when the user input for selecting the first object 610 is received.

As another embodiment, the processor of the aerosol generating device 10 may supply the second power to the heater so that the heater emits heat according to the second temperature profile when the user input for selecting the second object 620 is received.

Thus, the aerosol generating device 10 according to an embodiment may provide the user with an option to select the temperature profile of the heater by outputting the user interface 600 through the display D when the aerosol generating article (e.g., the second aerosol generating article 20b) of a different type than the previously inserted aerosol generating article (e.g., the first aerosol generating article 20a) is inserted.

In an embodiment, the user interface 600 may further include a switching object 640 for switching the user interface 600 output on the display D to another user interface. For example, when the user input for selecting switching object 640 is received, the aerosol generating device 10 may switch the user interface 600 showing various types of the aerosol generating article to another user interface (not shown).

In an embodiment, when the user input for selecting the switching object 640 is detected, the processor of the aerosol generating device 10 may not only switch the user interface 600 to another user interface, but may also stop the power supply to the heater.

As such, when the aerosol generating article is unintentionally inserted, the user may prevent the aerosol generating device 10 from heating the unintentionally inserted aerosol generating article by selecting the switching object 640. Details thereof will be described later.

FIG. 7 is a flowchart illustrating a method of controlling a display and power supplied to the heater based on the type of the aerosol generating article inserted in the aerosol generating device according to an embodiment. FIG. 7 illustrates the operation method for controlling the display and power supplied to the heater of the aerosol generating device 10 shown in FIGS. 3 and/or FIG. 5.

Referring to FIG. 7, the processor (e.g., the processor 120 of FIG. 3) of the aerosol generating device (e.g., the aerosol generating device 10 of FIG. 3) may detect the type of the aerosol generating article inserted in the accommodation space (e.g., the accommodation space 100h of FIG. 3) through the sensor (e.g., the sensor 140 of FIG. 3) in operation 701.

For example, the processor may obtain an inductance value corresponding to the type of the inserted aerosol generating article through the sensor, and may detect the type of the inserted aerosol generating article based on the obtained inductance value.

In operation 702, the processor of the aerosol generating device may detect whether the type of the aerosol generating article inserted in the accommodation space is different from that of the previously inserted aerosol generating article.

In an embodiment, the processor may detect whether the type of the aerosol generating article inserted in the accommodation space is different from the previously inserted aerosol generating article based on the inductance value corresponding to the inserted aerosol generating article detected in operation 701 and data stored in the memory. For example, the memory may store data relating to the inductance value corresponding to the previously inserted aerosol generating article, and the processor may compare the inductance value corresponding to the inserted aerosol generating article with the data stored in the memory to detect whether the type of the inserted aerosol generating article is different from that of the previously inserted aerosol generating article.

When it is detected that the type of the aerosol generating article inserted in operation 702 is different from that of the previously inserted aerosol generating article, the processor of the aerosol generating device may output a user interface (the user interface 600 of FIG. 6) showing various types of the aerosol generating article through the display (e.g., the display D of FIG. 6) in operation 703.

In an embodiment, the user interface may include at least one object corresponding to the type of the aerosol generating article. For example, the user interface may include the first object corresponding to the first aerosol generating article, the second object corresponding to the second aerosol generating article, and the third object corresponding to the third aerosol generating article, but embodiments are not limited thereto. That is, when the type of the inserted aerosol generating article is different from that of the previously inserted aerosol generating article, the aerosol generating device may output the user interface through the display, thereby informing the user that an aerosol generating article different from the previous one is inserted.

Unlike the above, when the type of the aerosol generating article inserted in operation 702 is detected to be the same as the that of the previously inserted aerosol generating article, the processor of the aerosol generating device may not output the user interface through the display, and may supply the same power as supplied for heating the previously inserted aerosol generating article to the heater.

In operation 704, the processor of the aerosol generating device may control the power supplied to the heater based on the user input on the user interface.

In an embodiment, the processor of the aerosol generating device may adjust the temperature profile of the heater by controlling the power supplied to the heater from the battery (the battery 130 of FIG. 3) based on the user input for selecting at least one object of the user interface. Detailed description thereof will be provided later.

When the type of the aerosol generating article inserted is different from the type of the previously inserted aerosol generating article, through operations 701 to 704, the aerosol generating device according to an embodiment may output the user interface to inform the user that an aerosol generating article different from the previous one is inserted and may provide the user with an option to select a temperature profile. Accordingly, the user may maintain a smoking sense even when the type of the inserted aerosol generating article changes, by selecting a temperature profile suitable for the type of the inserted aerosol generating article.

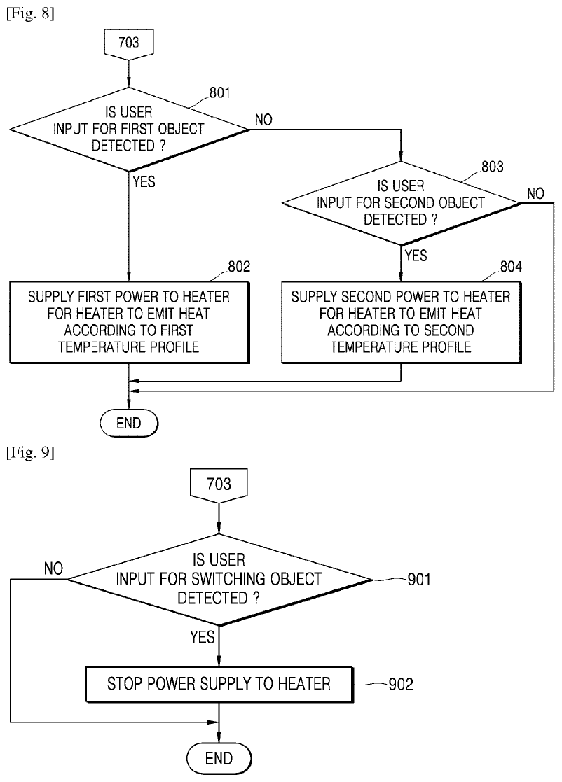

FIG. 8 is a flowchart illustrating a method for controlling power supplied to the heater based on the user input on the user interface of the aerosol generating device according to an embodiment. FIG. 8 is a flowchart illustrating operation 704 of FIG. 7 in detail.

In an embodiment, the user interface (e.g., the user interface 600 of FIG. 6) output on the display (e.g., the display D of FIG. 6) through operation 703 of FIG. 7 may include the first object (e.g., the first object 610 of FIG. 6) corresponding to the first aerosol generating article, the second object (e.g., the second object 620 of FIG. 6) corresponding to the second aerosol generating article, and the third object (e.g., the third object 630 of FIG. 6) corresponding to the third aerosol generating article.

Referring to FIG. 8, the processor (e.g., the processor 120 of FIG. 3) of the aerosol generating device (the aerosol generating device 10 of FIG. 3) may determine whether the user input for the first object of the user interface is detected in operation 801.

When it is determined that the user input for the first object is detected in operation 801, the processor of the aerosol generating device may supply the first power to the heater through the battery (e.g., the battery 130 of FIG. 3) in operation 802. For example, the processor may supply the first power to the heater so that the heater (e.g., the heater 110 of FIG. 3) may emit heat according to the first temperature profile based on the user input for the first object. That is, when the first aerosol generating article is newly inserted in the aerosol generating device and the user inputs the user input to the first object corresponding to the first aerosol generating article, the aerosol generating device may maintain the atomizing performance of the first aerosol generating article in an optimal state by controlling the heater to emit heat according the first temperature profile.

Unlike the above, when it is determined that the user input for the first object is not detected in operation 801, the processor of the aerosol generating device may determine whether the user input for the second object of the user interface is detected. In the drawings, only the embodiment in which step 803 is performed after step 801 is illustrated, but the embodiments are not limited to the illustrated embodiment. According to an embodiment, operations 801 and 803 may be performed simultaneously, or operation 803 may be performed before operation 801 is performed.

When it is determined that the user input for the second object is detected in operation 803, the processor of the aerosol generating device may supply the second power to the heater through the battery in operation 804. For example, the processor may supply the second power to the heater so that the heater may emit heat according to the second temperature profile based on the user input for the second object. That is, when the second aerosol generating article is newly inserted in the aerosol generating device and the user inputs the user input to the second object corresponding to the second aerosol generating article, the aerosol generating device may maintain the atomizing performance of the second aerosol generating article in an optimal state by controlling the heater to emit heat according the second temperature profile.

Although not illustrated in the figures, when it is determined that the user input for the second object is not detected in operation 803, the processor of the aerosol generating device may determine whether the user input for the third object of the user interface is detected. In this case, when the user input for the third object is detected, the processor of the aerosol generating device may supply the third power to the heater so that the heater may emit heat according to the third temperature profile.

That is, when an aerosol generating article different from the aerosol generating article previously inserted through operations 801 to 804 is newly inserted, the aerosol generating device according to an embodiment may control the supply of power so that the heater may emit heat according to a temperature profile suitable for the newly inserted aerosol generating article. As a result, the aerosol generating device according to an embodiment may maintain an optimal atomizing performance even when the type of the inserted aerosol generating article changes.

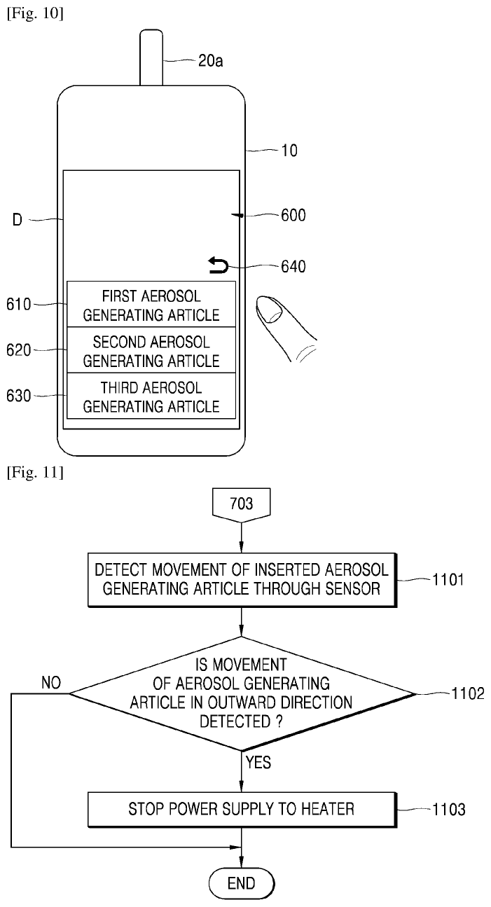

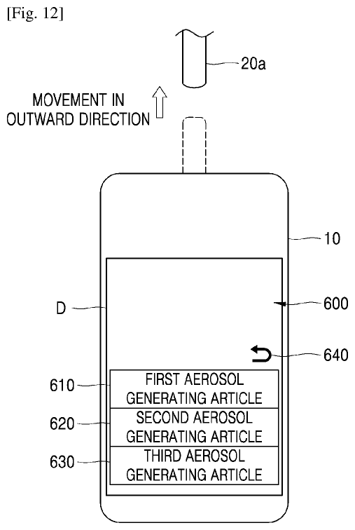

FIG. 9 is a flowchart illustrating a method of controlling power supplied to the heater based on the user input on a user interface of an aerosol generating device, and FIG. 10 is a view illustrating a state in which the first aerosol generating article is inserted in the aerosol generating device according to another embodiment.

Hereinafter, the method of FIG. 9, performed by the aerosol generating device, of controlling the power supplied to the heater will be described with reference to the components of FIG. 10.

In an embodiment, the user interface output on the display D through operation 703 of FIG. 7 may include the switching object 640 that switches the user interface 600 to another user interface in response to the user input, the first object 610 corresponding to the first aerosol generating article, the second object 620 corresponding to the second aerosol generating article, and the third object 630 corresponding to the third aerosol generating article. The user interface 600 according to an embodiment may be the same as or similar to the user interface 600 output from the aerosol generating device 10, and overlapping descriptions are omitted below.

Referring to FIGS. 9 and 10, the processor (e.g., the processor 120 of FIG. 3) of the aerosol generating device 10 may determine whether the user input for the switching object 640 of the user interface 600 is detected in operation 901.

In operation 902, when the user input for the switching object 640 is detected, the processor of the aerosol generating device 10 may stop the power supply to the heater (e.g., the heater 110 of FIG. 3). For example, when the user input for the switching object 640 is detected, the processor may determine that the insertion of the first aerosol generating article 20a was unintentional, and may stop the power supply to the heater so that the first aerosol generating article 20a is not heated.

That is, when the aerosol generating article (e.g., the first aerosol generating article 20a) is inserted, the user may input the user input for the switching object 640 of the user interface 600, thereby preventing the heating of the unintentionally inserted aerosol generating article.

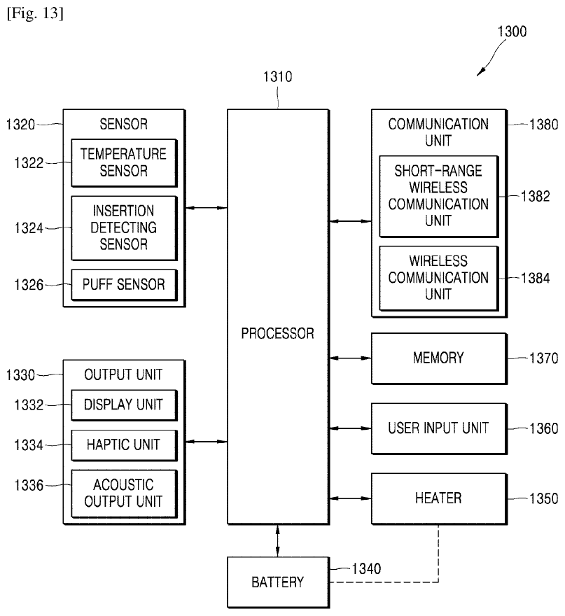

FIG. 11 is a flowchart illustrating a method of controlling power supplied to the heater based on the movement of the aerosol generating article of the aerosol generating device, and FIG. 12 is a view illustrating a state in which the first aerosol generating article moves in the outward direction from the aerosol generating device according to another embodiment.

Hereinafter, the method of FIG. 11, performed by the aerosol generating device, of controlling the power supplied to the heater will be described with reference to the components of FIG. 12. In this regards, FIG. 12 illustrates that the aerosol generating article (e.g., the first aerosol generating article 20a) different from the previously inserted aerosol generating article is inserted in the aerosol generating device 10 and thus the user interface 600 is output on the display D.

Referring to FIGS. 11 and 12, the processor (e.g., the processor 120 of FIG. 3) of the aerosol generating device 10 may detect the movement of the aerosol generating article inserted in the accommodation space (e.g., the accommodation space 100h of FIG. 3) through the sensor (e.g., the sensor 140 of FIG. 3) in operation 1101.

In an embodiment, the processor may obtain an amount of change of the inductance value corresponding to the movement of the first aerosol generating article 20a inserted in the accommodation space through the sensor, and the movement of the inserted first aerosol generating article 20a may be detected based on the obtained amount of change of the inductance value. For example, when the amount of change of the inductance value obtained through the sensor is greater than or equal to the preset value, the processor may detect the movement of the first aerosol generating article 20 in the outward direction. In this disclosure, “a movement in the outward direction” may refer to a movement of the aerosol generating article in a direction from the accommodation space to the outside of the aerosol generating device 10, and the expression may be used with the same meaning here below.

In operation 1102, the processor of the aerosol generating device 10 may determine whether a movement of the aerosol generating article inserted in the accommodation space in the outward direction has been detected. For example, the processor may determine whether a movement of the first aerosol generating article 20a inserted in the aerosol generating device 10 in the outward direction has been detected based on the detection result in operation 1101.

When a movement of the inserted aerosol generating article in the outward direction is detected in operation 1102, the processor of the aerosol generating device 10 may stop the power supply to the heater in operation 1103. For example, when a movement of the first aerosol generating article 20a inserted in the aerosol generating device in the outward direction is detected, the processor determines that the first aerosol generating article 20a has been unintentionally inserted, and may stop the power supply to the heater (e.g., the heater 110 of FIG. 3) so that the first aerosol generating article 20a is not heated.

Unlike the above, when the movement of the inserted aerosol generating article in the outward direction is not detected in operation 1102, the processor of the aerosol generating device 10 may wait until the user input is input on the user interface 600.

That is, when an aerosol generating article is unintentionally inserted and the user moves the aerosol generating article from the aerosol generating device to the outside or removes the aerosol generating article, through operations 1101 to 1103, the aerosol generating device 10 according to an embodiment may stop the power supply to the heater to prevent the unintentionally inserted aerosol generating article from being heated.

FIG. 13 is a block diagram of an aerosol generating device 1300 according to another embodiment.

The aerosol generating device 1300 may include a controller 1310, a sensing unit 1320, an output unit 1330, a battery 1340, a heater 1350, a user input unit 1360, a memory 1370, and a communication unit 1380. However, the internal structure of the aerosol generating device 1300 is not limited to those illustrated in FIG. 13. That is, according to the design of the aerosol generating device 1300, it will be understood by one of ordinary skill in the art that some of the components shown in FIG. 13 may be omitted or new components may be added.

The sensing unit 1320 may sense a state of the aerosol generating device 1300 and a state around the aerosol generating device 1300, and transmit sensed information to the controller 1310. Based on the sensed information, the controller 1310 may control the aerosol generating device 1300 to perform various functions, such as controlling an operation of the heater 1350, limiting smoking, determining whether an aerosol generating article (e.g., a cigarette, a cartridge, or the like) is inserted, displaying a notification, or the like.

The sensing unit 1320 may include at least one of a temperature sensor 1322, an insertion detection sensor, and a puff sensor 1326, but is not limited thereto.

The temperature sensor 1322 may sense a temperature at which the heater 1350 (or an aerosol generating material) is heated. The aerosol generating device 1300 may include a separate temperature sensor for sensing the temperature of the heater 1350, or the heater 1350 may serve as a temperature sensor. Alternatively, the temperature sensor 1322 may also be arranged around the battery 1340 to monitor the temperature of the battery 1340.

The insertion detection sensor 1324 may sense insertion and/or removal of an aerosol generating article. For example, the insertion detection sensor 1324 may include at least one of a film sensor, a pressure sensor, an optical sensor, a resistive sensor, a capacitive sensor, an inductive sensor, and an infrared sensor, and may sense a signal change according to the insertion and/or removal of an aerosol generating article.

The puff sensor 1326 may sense a user's puff on the basis of various physical changes in an airflow passage or an airflow channel. For example, the puff sensor 1326 may sense a user's puff on the basis of any one of a temperature change, a flow change, a voltage change, and a pressure change.

The sensing unit 1320 may include, in addition to the temperature sensor 1322, the insertion detection sensor 1324, and the puff sensor 1326 described above, at least one of a temperature/humidity sensor, a barometric pressure sensor, a magnetic sensor, an acceleration sensor, a gyroscope sensor, a location sensor (e.g., a global positioning system (GPS)), a proximity sensor, and a red-green-blue (RGB) sensor (illuminance sensor). Because the function of each sensor may be intuitively inferred from the name by one of ordinary skill in the art, the specific explanation may be omitted.

The output unit 1330 may output information on a state of the aerosol generating device 1300 and provide the information to a user. The output unit 1330 may include at least one of a display unit 1332, a haptic unit 1334, and a sound output unit 1336, but is not limited thereto. When the display unit 1332 and a touch pad form a layered structure to form a touch screen, the display unit 1332 may also be used as an input device in addition to an output device.

The display unit 1332 may visually provide information about the aerosol generating device 1300 to the user. For example, information about the aerosol generating device 1300 may mean various pieces of information, such as a charging/discharging state of the battery 1340 of the aerosol generating device 1300, a preheating state of the heater 1350, an insertion/removal state of an aerosol generating article, or a state in which the use of the aerosol generating device 1300 is restricted (e.g., sensing of an abnormal object), or the like, and the display unit 1332 may output the information to the outside. The display unit 1332 may be, for example, a liquid crystal display panel (LCD), an organic light-emitting diode (OLED) display panel, or the like. In addition, the display unit 1332 may be in the form of a light-emitting diode (LED) light-emitting device.

The haptic unit 1334 may tactilely provide information about the aerosol generating device 1300 to the user by converting an electrical signal into a mechanical stimulus or an electrical stimulus. For example, the haptic unit 1334 may include a motor, a piezoelectric element, or an electrical stimulation device.

The sound output unit 1336 may audibly provide information about the aerosol generating device 1300 to the user. For example, the sound output unit 1336 may convert an electrical signal into a sound signal and output the same to the outside.

The battery 1340 may supply power used to operate the aerosol generating device 1300. The battery 1340 may supply power such that the heater 1350 may be heated. In addition, the battery 1340 may supply power required for operations of other components (e.g., the sensing unit 1320, the output unit 1330, the user input unit 1360, the memory 1370, and the communication unit 1380) in the aerosol generating device 1300. The battery 1340 may be a rechargeable battery or a disposable battery. For example, the battery 1340 may be a lithium polymer (LiPoly) battery, but is not limited thereto.

The heater 1350 may receive power from the battery 1340 to heat an aerosol generating material. Although not illustrated in FIG. 13, the aerosol generating device 1300 may further include a power conversion circuit (e.g., a direct current (DC)/DC converter) that converts power of the battery 1340 and supplies the same to the heater 1350. In addition, when the aerosol generating device 1300 generates aerosols in an induction heating method, the aerosol generating device 1300 may further include a DC/alternating current (AC) that converts DC power of the battery 1340 into AC power.

The controller 1310, the sensing unit 1320, the output unit 1330, the user input unit 1360, the memory 1370, and the communication unit 1380 may each receive power from the battery 1340 to perform a function. Although not illustrated in FIG. 13, the aerosol generating device 1300 may further include a power conversion circuit that converts power of the battery 1340 to supply the power to respective components, for example, a low dropout (LDO) circuit, or a voltage regulator circuit.

In an embodiment, the heater 1350 may be formed of any suitable electrically resistive material. For example, the suitable electrically resistive material may be a metal or a metal alloy including titanium, zirconium, tantalum, platinum, nickel, cobalt, chromium, hafnium, niobium, molybdenum, tungsten, tin, gallium, manganese, iron, copper, stainless steel, nichrome, or the like, but is not limited thereto. In addition, the heater 1350 may be implemented by a metal wire, a metal plate on which an electrically conductive track is arranged, a ceramic heating element, or the like, but is not limited thereto.

In another embodiment, the heater 1350 may be a heater of an induction heating type. For example, the heater 1350 may include a susceptor that heats an aerosol generating material by generating heat through a magnetic field applied by a coil.

The user input unit 1360 may receive information input from the user or may output information to the user. For example, the user input unit 1360 may include a key pad, a dome switch, a touch pad (a contact capacitive method, a pressure resistance film method, an infrared sensing method, a surface ultrasonic conduction method, an integral tension measurement method, a piezo effect method, or the like), a jog wheel, a jog switch, or the like, but is not limited thereto. In addition, although not illustrated in FIG. 13, the aerosol generating device 1300 may further include a connection interface, such as a universal serial bus (USB) interface, and may connect to other external devices through the connection interface, such as the USB interface, to transmit and receive information, or to charge the battery 1340.

The memory 1370 is a hardware component that stores various types of data processed in the aerosol generating device 1300, and may store data processed and data to be processed by the controller 1310. The memory 1370 may include at least one type of storage medium from among a flash memory type, a hard disk type, a multimedia card micro type memory, a card-type memory (for example, secure digital (SD) or extreme digital (XD) memory, etc.), random access memory (RAM), static random access memory (SRAM), read-only memory (ROM), electrically erasable programmable read-only memory (EEPROM), programmable read-only memory (PROM), a magnetic memory, a magnetic disk, and an optical disk. The memory 1370 may store an operation time of the aerosol generating device 1300, the maximum number of puffs, the current number of puffs, at least one temperature profile, data on a user's smoking pattern, etc.

The communication unit 1380 may include at least one component for communication with another electronic device. For example, the communication unit 1380 may include a short-range wireless communication unit 1382 and a wireless communication unit 1384.

The short-range wireless communication unit 1382 may include a Bluetooth communication unit, a Bluetooth Low Energy (BLE) communication unit, a near field communication unit, a wireless LAN (WLAN) (Wi-Fi) communication unit, a Zigbee communication unit, an infrared data association (IrDA) communication unit, a Wi-Fi Direct (WFD) communication unit, an ultra-wideband (UWB) communication unit, an Ant+ communication unit, or the like, but is not limited thereto.

The wireless communication unit 1384 may include a cellular network communication unit, an Internet communication unit, a computer network (e.g., local area network (LAN) or wide area network (WAN)) communication unit, or the like, but is not limited thereto. The wireless communication unit 1384 may also identify and authenticate the aerosol generating device 1300 within a communication network by using subscriber information (e.g., International Mobile Subscriber Identifier (IMSI)).

The controller 1310 may control general operations of the aerosol generating device 1300. In an embodiment, the controller 1310 may include at least one processor. The processor may be implemented as an array of a plurality of logic gates or may be implemented as a combination of a general-purpose microprocessor and a memory in which a program executable by the microprocessor is stored. It will be understood by one of ordinary skill in the art that the processor may be implemented in other forms of hardware.

The controller 1310 may control the temperature of the heater 1350 by controlling supply of power of the battery 1340 to the heater 1350. For example, the controller 1310 may control power supply by controlling switching of a switching element between the battery 1340 and the heater 1350. In another example, a direct heating circuit may also control power supply to the heater 1350 according to a control command of the controller 1310.

The controller 1310 may analyze a result sensed by the sensing unit 1320 and control subsequent processes to be performed. For example, the controller 1310 may control power supplied to the heater 1350 to start or end an operation of the heater 1350 on the basis of a result sensed by the sensing unit 1320. As another example, the controller 1310 may control, based on a result sensed by the sensing unit 1320, an amount of power supplied to the heater 1350 and the time the power is supplied, such that the heater 1350 may be heated to a certain temperature or maintained at an appropriate temperature.

The controller 1310 may control the output unit 1330 on the basis of a result sensed by the sensing unit 1320. For example, when the number of puffs counted through the puff sensor 1326 reaches a preset number, the controller 1310 may notify the user that the aerosol generating device 1300 will soon be terminated through at least one of the display unit 1332, the haptic unit 1334, and the sound output unit 1336.

In an embodiment, the controller 1310 may control the time of power supply and/or amount of power supply to the heater 1350 according to a state of an aerosol generating article (e.g., the aerosol generating article 20 of FIG. 1) sensed by the sensing unit 1320. For example, when the aerosol generating article 20 is in an over-wet state, the controller 1310 may control the time of power supply to an induction coil to increase the pre-heating time of the aerosol generating article 20 compared to a general condition.

One embodiment may also be implemented in the form of a computer-readable recording medium including instructions executable by a computer, such as a program module executable by the computer. The computer-readable recording medium may be any available medium that may be accessed by a computer and includes both volatile and nonvolatile media, and removable and non-removable media. In addition, the computer-readable recording medium may include both a computer storage medium and a communication medium. The computer storage medium includes all of volatile and nonvolatile media, and removable and non-removable media implemented by any method or technology for storage of information such as computer-readable instructions, data structures, program modules, or other data. The communication medium typically includes computer-readable instructions, data structures, other data in modulated data signals such as program modules, or other transmission mechanisms, and includes any information transfer media.

The descriptions on the embodiments described above are merely examples, and it will be understood by those skilled in the art that various changes and equivalents thereof may be made. Therefore, the scope of the disclosure should be defined by the appended claims, and all differences within the scope equivalent to those described in the claims will be construed as being included in the scope of protection defined by the claims.

1. An aerosol generating apparatus comprising:
a housing comprising an accommodation space for accommodating an aerosol generating article;
a heater configured to heat an aerosol generating article inserted in the accommodation space;
a display arranged on the housing;
a sensor positioned to be adjacent to the accommodation space; and
a processor configured to detect a type of the aerosol generating article inserted in the accommodation space through the sensor,
wherein the processor is further configured to, when the type of the aerosol generating article inserted in the accommodation space is different from a type of a previously inserted aerosol generating article, display a user interface showing various types of the aerosol generating article through the display.

2. The aerosol generating device of claim 1, wherein the sensor comprises an inductance sensor configured to detect an inductance value corresponding to the type of the aerosol generating article inserted in the accommodation space.

3. The aerosol generating device of claim 2, wherein the processor is further configured to:
obtain the inductance value corresponding to the type of the aerosol generating article from the sensor, and
based on the obtained inductance value, detect the type of the aerosol generating article inserted in the accommodation space.

4. The aerosol generating device of claim 1, further comprising a memory storing data regarding the previously inserted aerosol generating article, wherein the processor is further configured to detect whether the type of the aerosol generating article inserted in the accommodation space is different from the type of the previously inserted aerosol generating article based on the data regarding the previously inserted aerosol generating article.

5. The aerosol generating device of claim 1, wherein the processor is further configured to, based on a user input on the user interface, control power supplied to the heater.

6. The aerosol generating device of claim 1, wherein the user interface comprises:
a first object corresponding to a first aerosol generating article; and
a second object corresponding to the second aerosol generating article different from the first aerosol generating article.

7. The aerosol generating device of claim 6, wherein the processor is further configured to:
when a user input for selecting the first object is received on the user interface, supply first power to the heater so that the heater emits heat according to a first temperature profile, and
when a user input for selecting the second object is received on the user interface, supply second power to the heater so that the heater emits heat according to a second temperature profile.

8. The aerosol generating device of claim 6, wherein
the user interface further comprises a switching object configured to switch the user interface to another user interface when selected, and the processor is further configured to, when a user input for selecting the switching object is received on the user interface, stop power supply to the heater.

9. The aerosol generating device of claim 1, wherein the processor is further configured to detect the aerosol generating article inserted in the accommodation space moving in an outward direction through the sensor.

10. The aerosol generating device of claim 9, wherein the processor is further configured to, when the aerosol generating article moves in the outward direction from the accommodation space, stop power supply to the heater.

11. The aerosol generating device of claim 1, wherein the heater comprises:
a coil configured to generate an alternating magnetic field; and
a susceptor configured to emit heat in response to the alternating magnetic field generated in the coil to heat the aerosol generating article inserted in the accommodation space.

12. An operation method of an aerosol generating device, the operation comprising:
detecting a type of an aerosol generating article inserted in an accommodation space through a sensor positioned adjacent to the accommodation space;
when the type of the aerosol generating article inserted in the accommodation space is different from a type of a previously inserted aerosol generating article, displaying a user interface showing various types of the aerosol generating article through a display; and
based on a user input on the user interface, controlling power supplied to a heater.

13. The method of claim 12, wherein the controlling of the power supplied to the heater comprises:
when a user input for selecting a first object corresponding to a first aerosol generating article is received, supplying first power to the heater so that the heater emits heat according to a first temperature profile; and
when a user input for selecting a second object corresponding to a second aerosol generating article, supplying second power to the heater so that the heater emits heat according to a second temperature profile.

14. The method of claim 12, wherein the controlling of the power supplied to the heater further comprises, when user input for selecting a switching object that switches the user interface to another user interface, stopping power supply to the heater.

15. The method of claim 12, further comprising:
In response to detecting the aerosol generating article inserted in the accommodation space moving in an outward direction through the sensor, stopping power supply to the heater.
